(19) United States
(12) Patent Application Publication
(10) Pub. No.: US 2026/0186239 A1
(43) Pub. Date: Jul. 2, 2026

(54) CAMERA OPTICAL LENS

(71) Applicant: Changzhou AAC Raytech Optronics Co., Ltd., Changzhou City (CN)

(72) Inventor: Pengfei Li, Changzhou (CN)

(21) Appl. No.: 19/322,666

(22) Filed: Sep. 8, 2025

Related U.S. Application Data
(63) Continuation of application No. PCT/CN2024/144644, filed on Dec. 31, 2024.

(51) Int. Cl. G02B 9/12; G02B 13/00

(52) U.S. Cl. CPC G02B 9/12; G02B 13/0065

(57) ABSTRACT

A camera optical lens comprises, arranged in sequence from an object side to an image side: a first lens with a positive refractive power, a second lens with a negative refractive power, a third lens with a negative refractive power, and a triangular prism. And the camera optical lens satisfies: 0.11≤D/TTL≤0.20; 0.10≤D/f≤0.22; 1.49≤ndi≤1.85; 0.32≤|SAG32|/SD32≤0.52; −20.03≤f3*d5/(R5−R6)≤−7.99.

### CROSS REFERENCE TO RELATED APPLICATIONS

The present application is a continuation of PCT Patent Application No. PCT/CN2024/144644, entitled “Camera Optical Lens,” filed Dec. 31, 2024, which is incorporated by reference herein in its entirety.

### TECHNICAL FIELD

The present disclosure relates to the field of optical lens, in particular to a camera optical lens suitable for portable terminal devices such as smart phones, digital cameras, unmanned aerial vehicles, and imaging devices such as monitors and PC lens.

### BACKGROUND

With the emergence of various intelligent equipment in recent years, the demand for miniature camera optical lens is increasing day by day. Due to the shrinkage of pixel size of photosensitive devices plus the development trend of electronic products towards excellent performance with light and portable shape, miniature camera optical lens with desirable imaging quality has become a mainstream in the current market. Telephoto camera lens can fulfill consumers' demand for capturing specific targets. Conventional telephoto camera lenses have excessive total track lengths, failing to meet the compact design requirements of smart phones. In contrast, the periscope-type telephoto camera lens design significantly reduces the total track length of the camera optical lens while achieving telephoto capabilities. However, the optical performance of existing periscope-type telephoto camera optical lenses still fails to satisfy current demands.

### SUMMARY

To address the aforementioned issues, the present disclosure aims to provide a camera optical lens capable of fulfilling large-aperture periscope-type design requirements while maintaining high imaging performance.

To address the above technical issues, embodiments of the present disclosure provide a camera optical lens comprising, arranged in sequence from the object side to the image side: a first lens L1 with a positive refractive power, a second lens L2 with a negative refractive power, a third lens L3 with a negative refractive power, and a triangular prism. At least one of the first lens, second lens, and third lens is a glass lens. An on-axis distance from the object side surface of the first lens to the image side surface of the third lens is denoted as D, a total track length of the camera optical lens is denoted as TTL, a focal length of the camera optical lens is denoted as f, a refractive index of the glass lens in the camera optical lens is denoted as ndi, a sagittal height at the maximum optical effective diameter of the image side surface of the third lens is denoted as SAG32, half of the maximum optical effective diameter of the image side surface of the third lens is denoted as SD32, a focal length of the third lens is denoted as f3, an on-axis thickness of the third lens is denoted as d5, a curvature radius of the object side surface of the third lens is denoted as R5, a curvature radius of the image side surface of the third lens is denoted as R6, the camera optical lens satisfies the following: 0.11≤D/TTL≤0.20; 0.10≤D/f≤0.22; 1.49≤ndi≤1.85; 0.32≤|SAG32|/SD32≤0.52; −20.03≤f3*d5/(R5−R6)≤−7.99.

In some embodiments, a combined focal length of the first lens and the second lens is denoted as f12, satisfying the following: 0.57≤f12/f≤0.71.

In some embodiments, an on-axis thickness of the first lens is denoted as d1, and an edge thickness of the first lens is denoted as ET1, satisfying the following: 2.48≤d1/ET1≤4.04.

In some embodiments, the object side surface of the first lens is convex in the paraxial region; f1 denotes a focal length of the first lens, R1 denotes a curvature radius of the object side surface of the first lens, R2 denotes a curvature radius of the image side surface of the first lens, and d1 denotes an on-axis thickness of the first lens, satisfying the following:

$$0.35 \leq f 1 / f \leq 0.6 ; - 1.65 \leq ( R 1 + R 2 ) / ( R 1 - R 2 ) \leq - 0.58 ; 0.055 \leq d 1 / TTL \leq 0.092 .$$

In some embodiments, f2 denotes a focal length of the second lens, R3 denotes a curvature radius of the object side surface of the second lens, R4 denotes a curvature radius of the image side surface of the second lens, and d3 denotes an on-axis thickness of the second lens, and the camera optical lens satisfies: −5.35≤f2/f≤−0.62; −16.01≤(R3+R4)/(R3−R4)≤11.06; 0.012≤d3/TTL≤0.036.

In some embodiments, the object side surface of the third lens is convex in a paraxial region, and the image side surface of the third lens is concave in the paraxial region, and the camera optical lens satisfies: −1.53≤f3/f≤−0.86; 3.99≤(R5+R6)/(R5−R6)≤7.77; 0.006≤d5/TTL≤0.067.

In some embodiments, an F-number of the camera optical lens is denoted as Fno, satisfying the following: Fno≤3.00.

In some embodiments, the total track length of the camera optical lens is denoted as TTL, the image height of the camera optical lens at the 1.0 field of view is IH, TTL and IH satisfying the following: TTL/IH≤13.91.

In some embodiments, the triangular prism is made of glass material.

The present disclosure has the following beneficial effects. The camera optical lens according to the present disclosure exhibits excellent optical characteristics, fulfilling design requirements for large aperture, periscope telephoto configuration, and miniaturization. It is particularly suitable for mobile phone camera modules and web camera lenses constituting imaging elements such as high-pixel CCD and CMOS sensors.

### BRIEF DESCRIPTION OF THE DRAWINGS

In order to illustrate the technical solutions in the embodiments of the present disclosure more clearly, the drawings used in the description of the embodiments are briefly described below. It is apparent that the drawings in the following description show only some embodiments of the present disclosure, and other drawings may be obtained by those of ordinary skill in the art based on these drawings without any creative efforts.

FIG. 1 is a schematic structural diagram of a camera optical lens according to a first embodiment of the present disclosure;

FIG. 2 illustrates the longitudinal aberration of the camera optical lens shown in FIG. 1;

FIG. 3 illustrates the magnification chromatic aberration of the camera optical lens shown in FIG. 1;

FIG. 4 presents a schematic diagram of the field curvature and distortion of the camera optical lens shown in FIG. 1;

FIG. 5 is a schematic structural diagram of a camera optical lens according to a second embodiment of the present disclosure;

FIG. 6 illustrates the longitudinal aberration of the camera optical lens shown in FIG. 5;

FIG. 7 illustrates the magnification chromatic aberration of the camera optical lens shown in FIG. 5;

FIG. 8 presents a schematic diagram of the field curvature and distortion of the camera optical lens shown in FIG. 5;

FIG. 9 is a schematic structural diagram of a camera optical lens according to a third embodiment of the present disclosure;

FIG. 10 illustrates the longitudinal aberration of the camera optical lens shown in FIG. 9;

FIG. 11 illustrates the magnification chromatic aberration of the camera optical lens shown in FIG. 9;

FIG. 12 presents a schematic diagram of the field curvature and distortion of the camera optical lens shown in FIG. 9;

FIG. 13 is a schematic structural diagram of a camera optical lens according to a fourth embodiment of the present disclosure;

FIG. 14 illustrates the longitudinal aberration of the camera optical lens shown in FIG. 13;

FIG. 15 illustrates the magnification chromatic aberration of the camera optical lens shown in FIG. 13;

FIG. 16 presents a schematic diagram of the field curvature and distortion of the camera optical lens shown in FIG. 13;

FIG. 17 is a schematic structural diagram of a camera optical lens according to a fifth embodiment of the present disclosure;

FIG. 18 illustrates the longitudinal aberration of the camera optical lens shown in FIG. 17;

FIG. 19 illustrates the magnification chromatic aberration of the camera optical lens shown in FIG. 17;

FIG. 20 presents a schematic diagram of the field curvature and distortion of the camera optical lens shown in FIG. 17.

### DETAILED DESCRIPTION OF THE EMBODIMENTS

In order to make the object, technical solution and advantages of the embodiments of the present disclosure clearer, the following gives a detailed description of the embodiments of the present disclosure with reference to the accompanying drawings. However, those of ordinary skill in the art may understand that in the embodiments of the present disclosure, many technical details have been presented to facilitate a better understanding of the present disclosure by the reader. However, even without these technical details and the various variations and modifications based on the following embodiments, the technical solution claimed in the present disclosure can still be achieved.

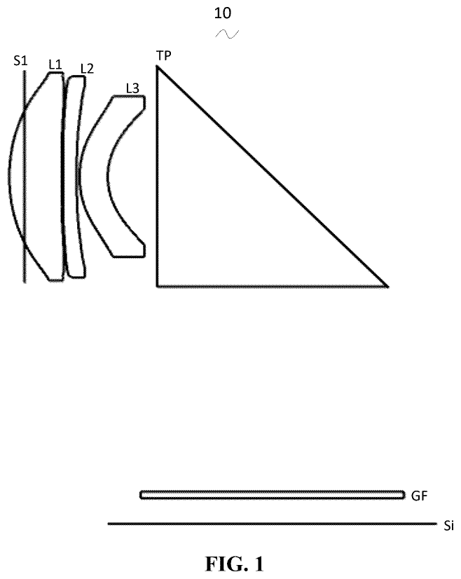

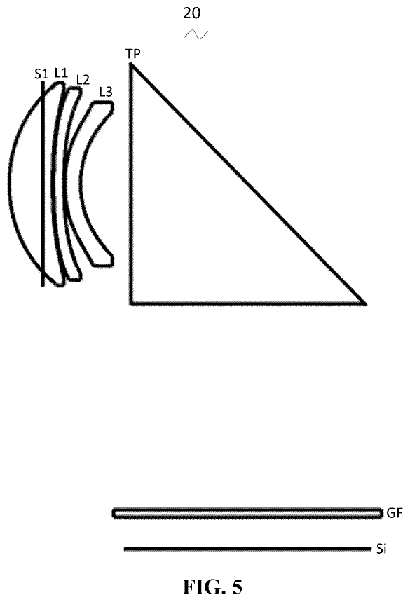

With reference to the accompanying drawings, the technical solution of the embodiments of the present disclosure provides camera optical lenses 10, 20, 30, 40 and 50. FIGS. 1, 5, 9, 13, and 17 show the camera optical lenses 10, 20, 30, 40 and 50 according to the present disclosure. Each camera optical lens comprises, arranged in sequence from the object side to the image side: a first lens L1 with a positive refractive power, a second lens L2 with a negative refractive power, a third lens L3 with a negative refractive power, and a triangular prism TP.

At least one of the first lens L1, second lens L2, and third lens L3 is a glass lens.

The on-axis distance from the object side surface of the first lens to the image side surface of the third lens in the camera optical lens 10, 20, 30, 40, or 50 is denoted as D, and the total track length is denoted as TTL, satisfying: 0.11≤D/TTL≤0.20, which specifies the ratio of the lens group length to the total track length of the camera optical lens. Compliance with this expression facilitates controlling the front segment length in periscope lens configurations.

A focal length of the camera optical lens 10, 20, 30, 40, or 50 is denoted as f, and the camera optical lens satisfies the following: 0.10≤D/f≤0.22, which specifies the ratio of the lens group length and the effective focal length of the total track length of the camera optical lens. Compliance with this expression facilitates telephoto imaging.

The refractive index of the glass lens in the camera optical lens is denoted as ndi, satisfying: 1.49≤ndi≤1.85, which specifies the refractive index of the used glass lens. Compliance with this expression permits optimal material property distribution for aberration correction and image quality enhancement.

The sagittal height at the maximum optical effective diameter of the image side surface of the third lens is denoted as SAG32, and half of the maximum optical effective diameter of the image side surface of the third lens is denoted as SD32, satisfying: 0.32≤|SAG32|/SD32≤0.52, which specifies the ratio of the sagittal height to the effective semi-diameter of the image side surface of the third lens L3. Compliance with this expression ensures superior stray light suppression and manufacturability.

The focal length of the third lens is denoted as f3, the on-axis thickness of the third lens is denoted as d5, the curvature radius of the object side surface of the third lens is denoted as R5, and the curvature radius of the image side surface of the third lens is denoted as R6, satisfying: −20.03≤f3*d5/(R5−R6)≤−7.99. Compliance with this expression facilitates shape control of the third lens L3 and enhances moldability.

Provided that the above conditions are all satisfied, the camera optical lenses 10, 20, 30, 40 and 50 have good optical performance and can meet the design requirements of large aperture, telephoto capability, and miniaturization. Due to the characteristics of the camera optical lenses 10, 20, 30, 40 and 50, these camera optical lenses are especially suitable for camera lens assemblies of mobile phones composed of camera elements such as CCD and CMOS for megapixel, and WEB cameras.

Based on the above conditions and the functions intended to achieved, the characteristics of each lens are further detailed as follows.

An object side surface of the first lens L1 is convex in a paraxial region, and an image side surface of the first lens L1 is convex or concave in the paraxial region. The object side surface of the first lens L1 may also be concave.

The combined focal length of the first and second lenses is defined as f12, satisfying: 0.57≤f12/f≤0.71, which specifies the ratio of the combined focal length of the first and second lenses to the total focal length of the camera optical lens. Rational allocation of the optical focal length of the camera optical lens achieves superior imaging quality with reduced tolerance sensitivity.

The on-axis thickness of the first lens is denoted as d1, and the edge thickness of the first lens is denoted as ET1, satisfying: 2.48≤d1/ET1≤4.04, which specifies the ratio of the central thickness to the edge thickness of the first lens, enhancing lens manufacturability and camera assembly feasibility.

The focal length of the first lens L1 is denoted as f1, and the focal length of the entire camera optical lens 10, 20, 30, 40, or 50 is denoted as f, satisfying: 0.35≤f1/f≤0.60. Compliance with this expression ensures the first lens to possess appropriate positive refractive power, effectively reducing system aberrations while facilitating miniaturization.

The curvature radius of the object side surface of the first lens L1 is denoted as R1, and the curvature radius of the image side surface of the first lens L1 is denoted as R2, satisfying the following: −1.65≤(R1+R2)/(R1−R2)≤−0.58, which reasonably controls the shape of the first lens, enabling the first lens to effectively correct the spherical aberration of the system.

The on-axis thickness d1 of the first lens L1 and the total track length TTL of the camera optical lens 10, 20, 30, 40, or 50 satisfy following: 0.055≤d1/TTL≤0.092, which facilitates miniaturization.

The object side surface of the second lens L2 is convex or concave in the paraxial region, and the image side surface of the second lens L2 is convex or concave in the paraxial region.

The focal length f2 of the second lens L2 and the focal length f of the entire camera optical lens 10, 20, 30, 40, or 50 satisfy: −5.35≤f2/f≤−0.62. Such condition controls the negative power of the second lens L2 to be within a reasonable range, which facilitates correction of the aberration of the optical system.

The curvature radius of the object side surface of the second lens L2 is denoted as R3, and the curvature radius of the image side surface of the second lens L2 is denoted as R4, satisfying the following: −16.01≤(R3+R4)/(R3−R4)≤11.06, which specifies the shape of the second lens L2. When the condition is satisfied, it facilitates the correction of on-axis chromatic aberration for the miniaturized lenses.

The on-axis thickness d3 of the second lens L2 and the total track length TTL of the camera optical lens 10, 20, 30, 40, or 50 satisfy following: 0.012≤d3/TTL≤0.036, which facilitates miniaturization.

An object side surface of the third lens L3 is convex in a paraxial region, and an image side surface of the third lens L3 is concave in the paraxial region. The object side surface and the image side surface of the third lens L3 may also have a concave-convex arrangement other than the above convex-concave arrangement.

The focal length f3 of the third lens L3 and the focal length f of the entire camera optical lens 10, 20, 30, 40, or 50 satisfy: −1.53≤B/f≤−0.86, which allows a reasonable allocation of focal power of the third lens, enabling the system to have better imaging quality and lower sensitivity.

The curvature radius of the object side surface of the third lens L3 is denoted as R5, and the curvature radius of the image side surface of the third lens L3 is denoted as R6, satisfying the following: 3.99≤(R5+R6)/(R5−R6)≤7.77, which effectively controls the shape of the third lens L3 and facilitates the forming of the third lens L3. When the condition is satisfied, it can mildly decrease the degree of refraction of light passing through the lens and effectively reduce the aberration.

The on-axis thickness d5 of the third lens L3 and the total track length TTL of the camera optical lens 10, 20, 30, 40, or 50 satisfy following: 0.006≤d5/TTL≤0.067, which facilitates miniaturization.

Incorporating the triangular prism TP enables optical path folding, thereby reducing the total length of the optical system to align with miniaturization trends in electronic devices.

For the camera optical lens 10, 20, 30, 40, or 50, the image height at 1.0 field is denoted as IH and the total track length is denoted as TTL, satisfying: TTL/IH≤13.91, which facilitates miniaturization.

The F-number of the camera optical lens 10, 20, 30, 40, or 50 is less than or equal to 3.00, exhibiting superior image-forming performance characteristic of large-aperture designs.

In the present disclosure, an aperture stop S1 is disposed between the object side and the first lens L1. The aperture stop S1 may be positioned at other positions.

Optical elements including an optical filter GF are arranged between the triangular prism TP and the image plane Si. The optical filter GF may be a glass cover plate or spectral filter. The optical filter GF may also be positioned at other positions.

The camera optical lens of the embodiments of the present disclosure is described with examples below. The symbols used in the examples are shown below. The units of focal length, on-axis distance, curvature radius, and on-axis thickness are millimeter.

TTL: total track length (the on-axis distance from the object side surface of the first lens L1 to the image plane Si), in millimeter; F-number FNO: ratio of an effective focal length of the camera optical lens to an entrance pupil diameter of the camera optical lens;

IH at 1.0 field: field height corresponding to the sensor's effective image element (i.e., half the diagonal length of the senor's effective image element region);

FOV at 1.0 field: Field of view corresponding to the sensor's effective image element;

Image Height at MIC Field (IHm): an extended field height beyond 1.0 field, compensating for assembly tolerances;

Field of View at MIC Field (FOVm): the field of view corresponding to IHm.

The technical solutions of the present disclosure are detailed below through five embodiments.

### First Embodiment

The first lens L1 possesses a positive refractive power and is made of glass material. Its object side surface is convex in the paraxial region, and its image side surface is convex in the paraxial region.

The second lens L2 possesses a negative refractive power and is made of plastic material. Its object side surface is convex in the paraxial region, and its image side surface is concave in the paraxial region.

The third lens L3 possesses a negative refractive power and is made of plastic material. Its object side surface is convex in the paraxial region, and its image side surface is concave in the paraxial region.

Tables 1, 2 and 3 show design data of the camera optical lens 10 according to the first embodiment of the present disclosure.

TABLE 1

| | R | d | | nd | | vd | |
|---|---|---|---|---|---|---|---|
| S1 | ∞ | d0= | −0.460 | | | | |
| R1 | 5.316 | d1= | 1.600 | nd1 | 1.4959 | vd1 | 81.65 |
| R2 | −24.225 | d2= | 0.030 | | | | |
| R3 | 626.915 | d3= | 0.412 | nd2 | 1.6700 | vd2 | 19.39 |
| R4 | 34.369 | d4= | 0.092 | | | | |
| R5 | 3.324 | d5= | 0.853 | nd3 | 1.5444 | vd3 | 55.82 |
| R6 | 2.183 | d6= | 1.500 | | | | |
| R7 | ∞ | d7= | 6.982 | nd4 | 1.5891 | vd4 | 61.25 |
| R8 | ∞ | d8= | 6.500 | | | | |
| R9 | ∞ | d9= | 0.210 | ndg | 1.5168 | vdg | 64.17 |
| R10 | ∞ | d10= | 0.807 | | | | |

Specific meanings of the symbols therein are listed as follow:
S1: aperture;
R: curvature radius of optical surfaces or central curvature radius for a lens;
R1: curvature radius of the object side surface of the first lens L1;
R2: curvature radius of the image side surface of the first lens L1;
R3: curvature radius of the object side surface of the second lens L2;
R4: curvature radius of the image side surface of the second lens L2;
R5: curvature radius of the object side surface of the third lens L3;
R6: curvature radius of the image side surface of the third lens L3;
R7 curvature radius of the object side surface of the triangular prism TP;
R8: curvature radius of the image side surface of the triangular prism TP;
R9: curvature radius of the object side surface of the optical filter GF;
R10: curvature radius of the image side surface of the optical filter GF;
d: on-axis thickness of the lens, or on-axis distance between the lenses;
d0: distance on-axis from the aperture S1 to the object side surface of the first lens L1;
d1: thickness on-axis of the first lens L1;
d2: distance on-axis from the image side surface of the first lens L1 to the object side surface of the second lens L2;
d3: thickness on-axis of the second lens L2;
d4: distance on-axis from the image side surface of the second lens L2 to the object side surface of the third lens L3;
d5: thickness on-axis of the third lens L3;
d6: distance on-axis from the image side surface of the third lens L3 to the object side surface of the triangular prism TP;
d7: on-axis thickness of the triangular prism TP;
d8: on-axis distance from the image side surface of the triangular prism TP to the object side surface of the optical filter GF;
d9: thickness on-axis of the optical filter GF;
d10: on-axis distance from the image side surface of the optical filter GF to the image surface S1;
nd: refractive index at d-line;
nd1: refractive index at d-line of the first lens L1;
nd2: refractive index at d-line of the second lens L2;
nd3: refractive index at d-line of the third lens L3;
nd4: refractive index at d-line of the triangular prism TP;
ndg: refractive index of the optical filter GF for d-line;
vd: Abbe number;
vd1: Abee number of the first lens L1;
vd2: Abee number of the second lens L2;
vd3: Abee number of the third lens L3;
vd4: Abee number of the triangular prism TP;
vdg: Abee number of the optical filter GF.

Table 2 shows the aspherical data of the lenses in the camera optical lens 10 of the first embodiment of the present disclosure.

TABLE 2

| | |
|---|---|
| Conic constant | Aspheric coefficient |

| | k | A4 | A6 | A8 | A10 | A12 |
|---|---|---|---|---|---|---|
| R1 | −9.5839E−01 | 3.0795E−03 | −5.0356E−04 | 8.2246E−04 | −8.7499E−04 | 5.7935E−04 |
| R2 | 5.5038E+00 | 2.5011E−02 | −7.0471E−03 | −1.4091E−02 | 2.3707E−02 | −1.7833E−02 |
| R3 | −1.7612E+01 | 1.5880E−03 | 8.8151E−03 | −2.5958E−02 | 3.1888E−02 | −2.1849E−02 |
| R4 | 2.3770E+01 | 5.1040E−03 | 6.1473E−03 | −2.3819E−02 | 2.9936E−02 | −2.0411E−02 |
| R5 | −2.9244E+00 | 3.8830E−02 | −1.5737E−02 | −2.1500E−03 | 7.7579E−03 | −3.5393E−03 |
| R6 | −1.2949E+00 | 1.8388E−02 | −1.6621E−02 | 4.2034E−02 | −8.2288E−02 | 1.0469E−01 |

| | Conic constant | Aspheric coefficient | | | | |
|---|---|---|---|---|---|---|
| | k | A14 | A16 | A18 | A20 | A22 |
| R1 | −9.5839E−01 | −2.6080E−04 | 8.2927E−05 | −1.8914E−05 | 3.1033E−06 | −3.6308E−07 |
| R2 | 5.5038E+00 | 8.1728E−03 | −2.5055E−03 | 5.3547E−04 | −8.1113E−05 | 8.6956E−06 |
| R3 | −1.7612E+01 | 9.5621E−03 | −2.8616E−03 | 6.0579E−04 | −9.1903E−05 | 9.9544E−06 |
| R4 | 2.3770E+01 | 8.8665E−03 | −2.6505E−03 | 5.6649E−04 | −8.7867E−05 | 9.8584E−06 |
| R5 | −2.9244E+00 | −2.9378E−04 | 9.1821E−04 | −4.3887E−04 | 1.1730E−04 | −2.0213E−05 |
| R6 | −1.2949E+00 | −8.8968E−02 | 5.2321E−02 | −2.1841E−02 | 6.5450E−03 | −1.4023E−03 |

| | Conic constant | Aspheric coefficient | | | | |
|---|---|---|---|---|---|---|
| | k | A24 | A26 | A28 | A30 | / |
| R1 | −9.5839E−01 | 2.9552E−08 | −1.5899E−09 | 5.0813E−11 | −7.3025E−13 | / |
| R2 | 5.5038E+00 | −6.4626E−07 | 3.1716E−08 | −9.2548E−10 | 1.2170E−11 | / |
| R3 | −1.7612E+01 | −7.5299E−07 | 3.7853E−08 | −1.1379E−09 | 1.5500E−11 | / |
| R4 | 2.3770E+01 | −7.8236E−07 | 4.1768E−08 | −1.3493E−09 | 1.9981E−11 | / |
| R5 | −2.9244E+00 | 2.3058E−06 | −1.6922E−07 | 7.2558E−09 | −1.3813E−10 | / |
| R6 | −1.2949E+00 | 2.0999E−04 | −2.0895E−05 | 1.2413E−06 | −3.3302E−08 | / |

For convenience, the aspherical surfaces of the lenses conform to the following formula (1): However, the present disclosure is not limited to the aspherics defined in a polynomial form represented by the formula (1).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} \qquad ( 1 )$$

where K denotes a conic coefficient, A4, A6, A8, A10, A12, A14, A16, A18, A20, A22, A24, A26, A28 and A30 denote aspherical coefficients, c denotes a curvature at the center of the optical surface, r denotes a vertical distance between a point on the aspherical curve and the optical axis, z denotes a depth of the aspherical surface (the vertical distance between a point on the aspherical surface with a distance of r from the optical axis and a tangent plane tangential to the vertex on the optical axis of the aspherical surface).

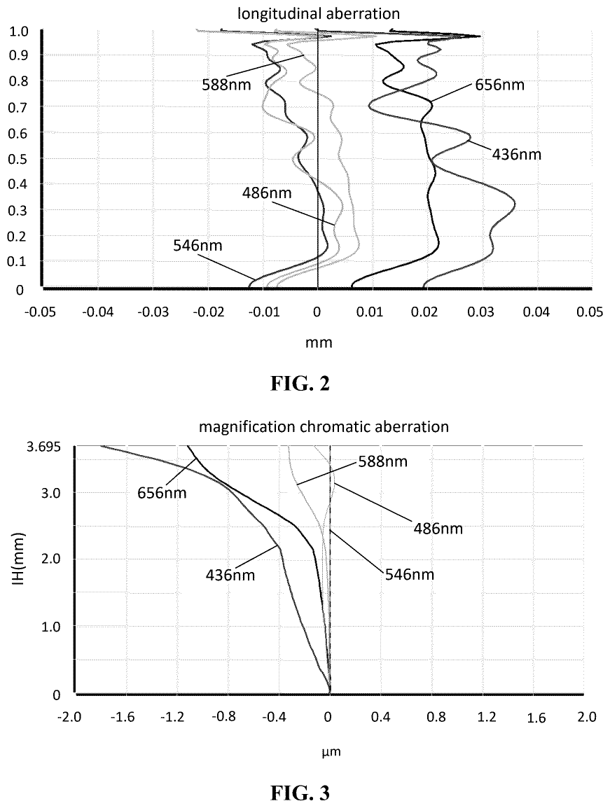

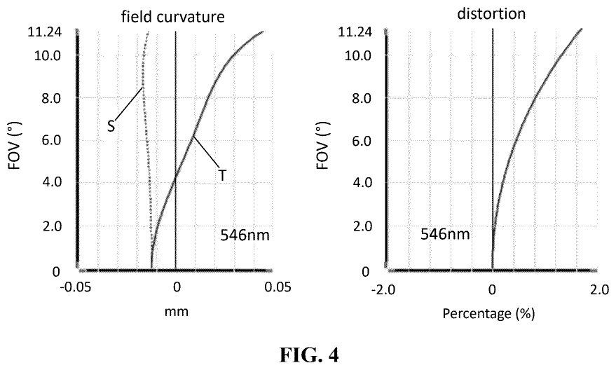

FIG. 2 and FIG. 3 show the longitudinal aberration and magnification chromatic aberration after light with a wavelength respectively of 656 nm, 588 nm, 546 nm, 486 nm and 436 nm passes the camera optical lens 10 in the first embodiment. FIG. 4 shows the field curvature and distortion after light with a wavelength of 546 nm passes the camera optical lens 10 in the first embodiment, where the field curvature S in FIG. 4 denotes a field curvature in the sagittal direction, and T denotes a field curvature in the meridian direction.

In this embodiment, the entrance pupil diameter ENPD of the camera optical lens 10 is 6.363 mm, the image height IH at 1.0 field is 3.575 mm, a field of view FOV at 1.0 field is 21.79°, IHm is 3.695 mm, and FOVm is 22.48°. The camera optical lens 10 satisfies design requirements for large aperture, telephoto capability, and miniaturization. It achieves full correction of both on-axis and off-axis chromatic aberrations while exhibiting excellent optical characteristics.

### Second Embodiment

The meanings of the symbols of the second embodiment are the same as those of the first embodiment.

It differs from the first embodiment in that: the image side surface of the first lens L1 is concave in the paraxial region.

Tables 3 and 4 show design data of the camera optical lens 20 according to the second embodiment of the present disclosure.

TABLE 3

| | R | d | | nd | | vd | |
|---|---|---|---|---|---|---|---|
| S1 | ∞ | d0= | −1.012 | | | | |
| R1 | 3.982 | d1= | 1.297 | nd1 | 1.4959 | vd1 | 81.64 |
| R2 | 36.568 | d2= | 0.036 | | | | |
| R3 | 18.335 | d3= | 0.300 | nd2 | 1.6700 | vd2 | 19.39 |
| R4 | 12.136 | d4= | 0.030 | | | | |
| R5 | 4.073 | d5= | 0.466 | nd3 | 1.5444 | vd3 | 55.82 |
| R6 | 2.871 | d6= | 1.500 | | | | |
| R7 | ∞ | d7= | 6.982 | nd4 | 1.5891 | vd4 | 61.25 |
| R8 | ∞ | d8= | 6.000 | | | | |
| R9 | ∞ | d9= | 0.210 | ndg | 1.5168 | vdg | 64.17 |
| R10 | ∞ | d10= | 0.925 | | | | |

Table 4 shows the aspherical data of the lenses in the camera optical lens 20 of the second embodiment of the present disclosure.

TABLE 4

| | Conic constant | Aspheric coefficient | | | | |
|---|---|---|---|---|---|---|
| | k | A4 | A6 | A8 | A10 | A12 |
| R1 | −5.3865E−01 | 3.3646E−03 | −9.3315E−04 | 1.1657E−03 | −1.2107E−03 | 8.7021E−04 |
| R2 | −9.9000E+01 | 2.8619E−02 | −1.1924E−02 | −1.2748E−02 | 2.5860E−02 | −2.0518E−02 |
| R3 | 3.8936E+01 | −2.6893E−05 | 1.1364E−02 | −2.8632E−02 | 3.5022E−02 | −2.4456E−02 |
| R4 | 1.8682E+01 | −4.6095E−03 | 1.6094E−02 | −2.4073E−02 | 2.3724E−02 | −1.4846E−02 |
| R5 | −2.6351E+00 | 3.2289E−02 | −1.0837E−02 | 1.5510E−03 | 9.2752E−04 | 4.9716E−04 |
| R6 | −9.4996E−01 | 1.8815E−02 | −2.3765E−02 | 6.3908E−02 | −1.1619E−01 | 1.4185E−01 |
| | Conic constant | Aspheric coefficient | | | | |
| | k | A14 | A16 | A18 | A20 | A22 |
| R1 | −5.3865E−01 | −4.2888E−04 | 1.4854E−04 | −3.6697E−05 | 6.4985E−06 | −8.1913E−07 |
| R2 | −9.9000E+01 | 9.7232E−03 | −3.0651E−03 | 6.7238E−04 | −1.0448E−04 | 1.1488E−05 |
| R3 | 3.8936E+01 | 1.0941E−02 | −3.3444E−03 | 7.2250E−04 | −1.1180E−04 | 1.2350E−05 |
| R4 | 1.8682E+01 | 6.1518E−03 | −1.7655E−03 | 3.6146E−04 | −5.3520E−05 | 5.7193E−06 |
| R5 | −2.6351E+00 | −1.5833E−03 | 1.1858E−03 | −4.8569E−04 | 1.2614E−04 | −2.1751E−05 |
| R6 | −9.4996E−01 | −1.1997E−01 | 7.1883E−02 | −3.0949E−02 | 9.6164E−03 | −2.1402E−03 |

| | Conic constant | Aspheric coefficient | | | | |
|---|---|---|---|---|---|---|
| | k | A24 | A26 | A28 | A30 | / |
| R1 | −5.3865E−01 | 7.1790E−08 | −4.1587E−09 | 1.4312E−10 | −2.2147E−12 | / |
| R2 | −9.9000E+01 | −8.7572E−07 | 4.4080E−08 | −1.3192E−09 | 1.7793E−11 | / |
| R3 | 3.8936E+01 | −9.5269E−07 | 4.8840E−08 | −1.4973E−09 | 2.0798E−11 | / |
| R4 | 1.8682E+01 | −4.3196E−07 | 2.1948E−08 | −6.7474E−10 | 9.5095E−12 | / |
| R5 | −2.6351E+00 | 2.4980E−06 | −1.8455E−07 | 7.9661E−09 | −1.5267E−10 | / |
| R6 | −9.4996E−01 | 3.3306E−04 | −3.4439E−05 | 2.1261E−06 | −5.9275E−08 | / |

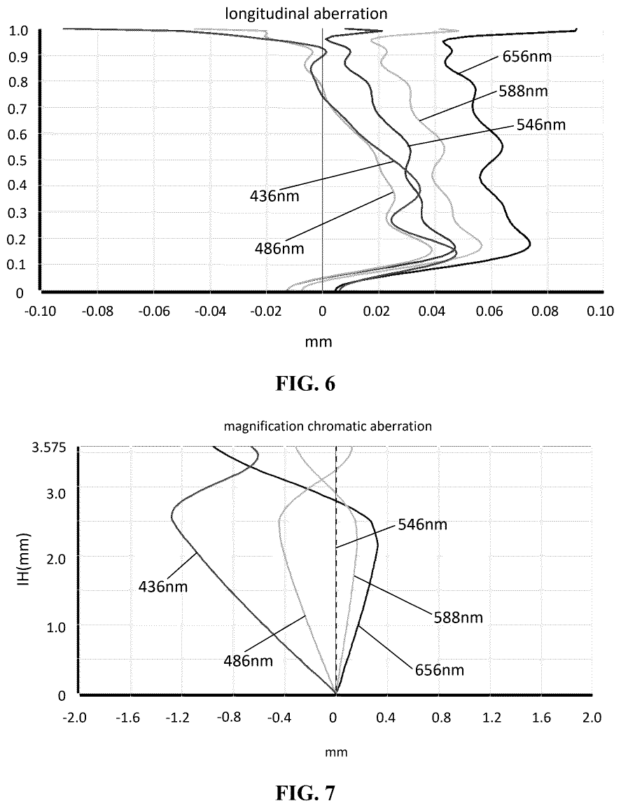

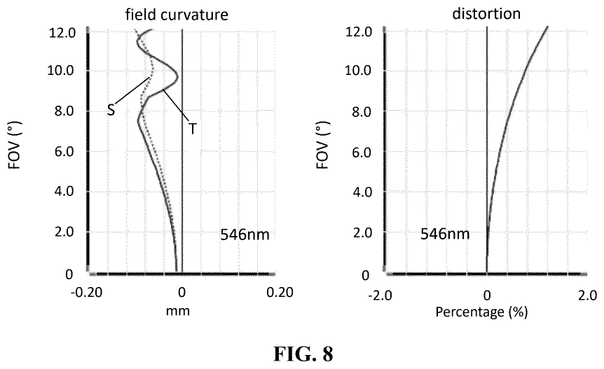

FIG. 6 and FIG. 7 show the longitudinal aberration and magnification chromatic aberration after light with a wavelength respectively of 656 nm, 588 nm, 546 nm, 486 nm and 436 nm passes the camera optical lens 20 in the second embodiment. FIG. 8 shows the field curvature and distortion after light with a wavelength of 546 nm passes the camera optical lens 20 in the second embodiment, where the field curvature S in FIG. 8 denotes a field curvature in the sagittal direction, and T denotes a field curvature in the meridian direction.

In this embodiment, the entrance pupil diameter ENPD of the camera optical lens 20 is 5.671 mm, the image height IH at 1.0 field is 3.575 mm, a field of view FOV at 1.0 field is 24.47°, IHm is 3.695 mm, and FOVm is 25.24°. The camera optical lens 20 satisfies design requirements for large aperture, telephoto capability, and miniaturization. It achieves full correction of both on-axis and off-axis chromatic aberrations while exhibiting excellent optical characteristics.

### Third Embodiment

The meanings of the symbols of the third embodiment are the same as those of the first embodiment.

It differs from the first embodiment in that: The object side surface of the second lens L2 is concave in the paraxial region, and the image side surface of the second lens L2 is convex in the paraxial region.

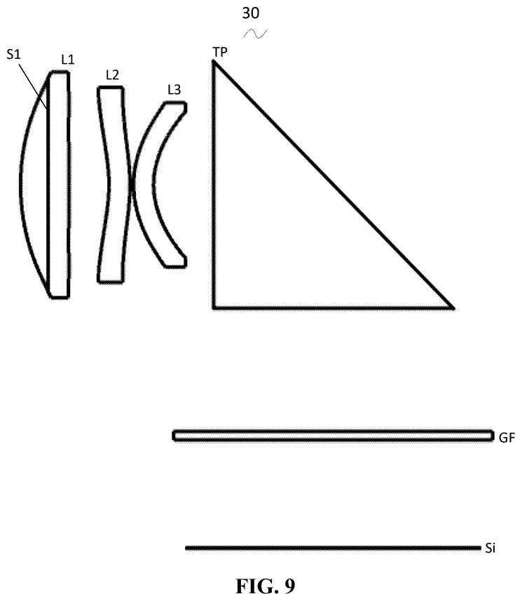

FIG. 9 shows a camera optical lens 30 according to a third embodiment of the present disclosure.

Tables 5 and 6 show design data of the camera optical lens 30 according to the third embodiment of the present disclosure.

TABLE 5

| | R | d | | nd | | vd | |
|---|---|---|---|---|---|---|---|
| S1 | ∞ | d0= | −0.694 | | | | |
| R1 | 5.165 | d1= | 1.216 | nd1 | 1.4959 | vd1 | 81.64 |
| R2 | −32.896 | d2= | 0.999 | | | | |
| R3 | −3.504 | d3= | 0.528 | nd2 | 1.6700 | vd2 | 19.39 |
| R4 | −3.971 | d4= | 0.089 | | | | |
| R5 | 2.406 | d5= | 0.501 | nd3 | 1.5444 | vd3 | 55.82 |
| R6 | 1.857 | d6= | 1.500 | | | | |
| R7 | ∞ | d7= | 6.000 | nd4 | 1.5891 | vd4 | 61.25 |
| R8 | ∞ | d8= | 3.000 | | | | |
| R9 | ∞ | d9= | 0.210 | ndg | 1.5168 | vdg | 64.17 |
| R10 | ∞ | d10= | 2.623 | | | | |

Table 6 shows the aspherical data of the lenses in the camera optical lens 30 of the third embodiment of the present disclosure.

TABLE 6

| | Conic constant | Aspheric coefficient | | | | |
|---|---|---|---|---|---|---|
| | k | A4 | A6 | A8 | A10 | A12 |
| R1 | −1.5002E+00 | 2.3347E−03 | 3.0960E−04 | −1.4705E−04 | −2.2628E−04 | 2.7954E−04 |
| R2 | 9.9000E+01 | 7.8385E−03 | −4.4630E−04 | −2.0570E−03 | 1.7713E−03 | −7.7472E−04 |
| R3 | −2.5726E+01 | −7.2994E−03 | 2.7680E−02 | −4.7632E−02 | 4.8122E−02 | −3.0715E−02 |
| R4 | −4.3192E+01 | 7.2461E−03 | −4.7570E−03 | −1.4511E−02 | 2.9272E−02 | −2.4436E−02 |
| R5 | −3.1245E+00 | 4.3710E−02 | −6.6034E−02 | 6.2653E−02 | −3.3380E−02 | 1.0693E−02 |
| R6 | −1.5059E+00 | −2.2573E−02 | 4.0120E−02 | −5.0314E−02 | 4.8639E−02 | −2.9703E−02 |
| | Conic constant | Aspheric coefficient | | | | |
| | k | A14 | A16 | A18 | A20 | A22 |
| R1 | −1.5002E+00 | −1.5062E−04 | 4.9660E−05 | −1.1067E−05 | 1.7309E−06 | −1.9140E−07 |
| R2 | 9.9000E+01 | 2.1007E−04 | −3.8087E−05 | 4.7927E−06 | −4.2653E−07 | 2.6949E−08 |
| R3 | −2.5726E+01 | 1.3232E−02 | −4.0082E−03 | 8.7184E−04 | −1.3698E−04 | 1.5422E−05 |
| R4 | −4.3192E+01 | 1.2176E−02 | −4.0479E−03 | 9.4250E−04 | −1.5693E−04 | 1.8731E−05 |
| R5 | −3.1245E+00 | −2.2191E−03 | 3.7566E−04 | −7.6799E−05 | 1.6072E−05 | −2.3617E−06 |
| R6 | −1.5059E+00 | 1.0304E−02 | −1.4742E−03 | −2.3392E−04 | 1.3942E−04 | −2.6097E−05 |

| | Conic constant | Aspheric coefficient | | | | |
|---|---|---|---|---|---|---|
| | k | A24 | A26 | A28 | A30 | / |
| R1 | −1.5002E+00 | 1.4698E−08 | −7.4601E−10 | 2.2495E−11 | −3.0500E−13 | / |
| R2 | 9.9000E+01 | −1.1846E−09 | 3.4387E−11 | −5.9348E−13 | 4.6161E−15 | / |
| R3 | −2.5726E+01 | −1.2140E−06 | 6.3506E−08 | −1.9866E−09 | 2.8158E−11 | / |
| R4 | −4.3192E+01 | −1.5758E−06 | 8.9181E−08 | −3.0539E−09 | 4.7942E−11 | / |
| R5 | −3.1245E+00 | 2.2164E−07 | −1.3382E−08 | 4.7205E−10 | −7.3932E−12 | / |
| R6 | −1.5059E+00 | 2.7206E−06 | −1.8846E−07 | 7.7941E−09 | −1.4557E−10 | / |

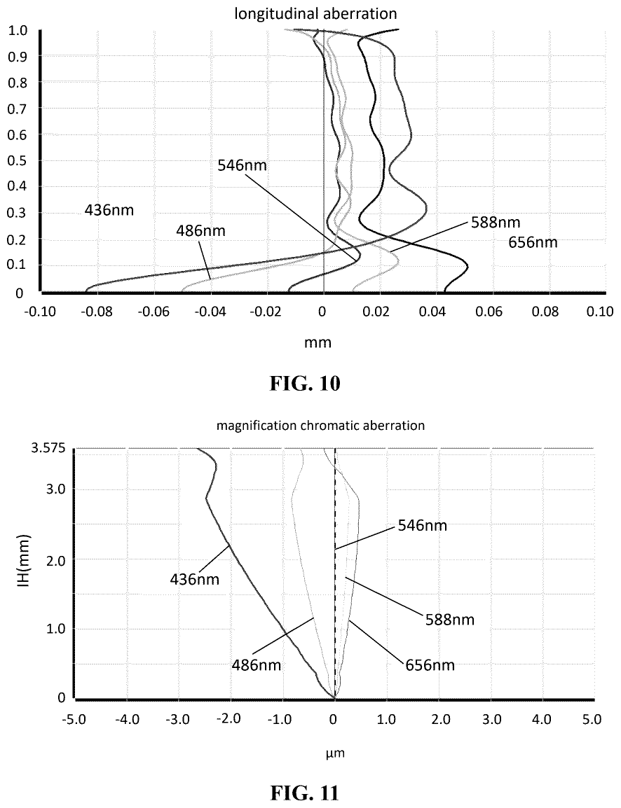

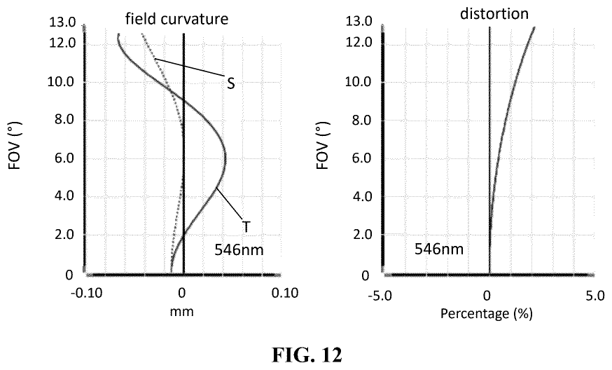

FIG. 10 and FIG. 11 show the longitudinal aberration and magnification chromatic aberration after light with a wavelength respectively of 656 nm, 588 nm, 546 nm, 486 nm and 436 nm passes the camera optical lens 30 in the third embodiment. FIG. 12 shows the field curvature and distortion after light with a wavelength of 546 nm passes the camera optical lens 30 in the third embodiment, where the field curvature S in FIG. 12 denotes a field curvature in the sagittal direction, and T denotes a field curvature in the meridian direction.

In this embodiment, the entrance pupil diameter ENPD of the camera optical lens 30 is 5.265 mm, the image height IH at 1.0 field is 3.575 mm, a field of view FOV at 1.0 field is 26.02°, IHm is 3.695 mm, and FOVm is 26.83°. The camera optical lens 30 satisfies design requirements for large aperture, telephoto capability, and miniaturization. It achieves full correction of both on-axis and off-axis chromatic aberrations while exhibiting excellent optical characteristics.

### Fourth Embodiment

The meanings of the symbols of the fourth embodiment are the same as those of the first embodiment.

It differs from the first embodiment in that: The image side surface of the first lens L1 is concave in the paraxial region.

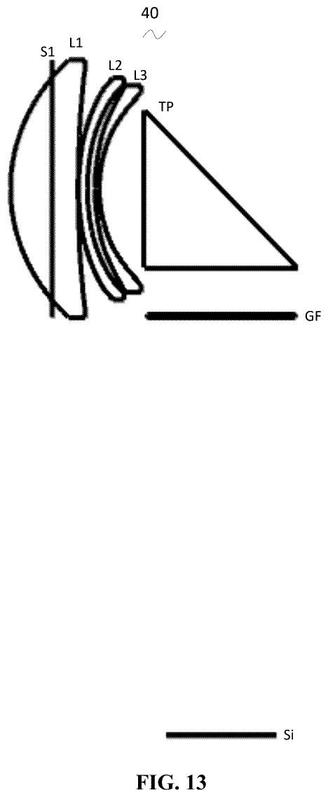

FIG. 13 shows a camera optical lens 40 according to a fourth embodiment of the present disclosure.

Tables 7 and 8 show design data of the camera optical lens 40 according to the fourth embodiment of the present disclosure.

TABLE 7

| | R | d | | nd | | vd | |
|---|---|---|---|---|---|---|---|
| S1 | ∞ | d0= | −2.780 | | | | |
| R1 | 10.257 | d1= | 4.536 | nd1 | 1.4959 | vd1 | 81.64 |
| R2 | 42.013 | d2= | 0.030 | | | | |
| R3 | 12.816 | d3= | 0.600 | nd2 | 1.6700 | vd2 | 19.39 |
| R4 | 10.689 | d4= | 0.498 | | | | |
| R5 | 10.956 | d5= | 0.300 | nd3 | 1.5444 | vd3 | 55.82 |
| R6 | 8.392 | d6= | 3.000 | | | | |
| R7 | ∞ | d7= | 10.375 | nd4 | 1.5891 | vd4 | 61.25 |
| R8 | ∞ | d8= | 3.000 | | | | |
| R9 | ∞ | d9= | 0.210 | ndg | 1.5168 | vdg | 64.17 |
| R10 | ∞ | d10= | 27.148 | | | | |

Table 8 shows the aspherical data of the lenses in the camera optical lens 40 of the fourth embodiment of the present disclosure.

TABLE 8

| | Conic constant | Aspheric coefficient | | | | |
|---|---|---|---|---|---|---|
| | k | A4 | A6 | A8 | A10 | A12 |
| R1 | −5.1243E−01 | 1.2695E−04 | −2.0220E−05 | 1.9080E−06 | −1.4475E−07 | 9.0892E−09 |
| R2 | −9.9000E+01 | −4.8248E−04 | 1.0747E−05 | 7.4737E−07 | 1.7226E−08 | −4.8730E−09 |
| R3 | −1.0503E+01 | −2.7070E−03 | 6.2406E−04 | −8.0489E−05 | 8.8243E−06 | −8.1327E−07 |
| R4 | −3.1828E+01 | −8.4888E−04 | 4.0491E−04 | −4.9371E−05 | 5.5501E−06 | −6.2596E−07 |
| R5 | −2.6216E+00 | 7.2062E−04 | −4.2806E−04 | 5.3331E−05 | −2.7684E−06 | 4.8402E−08 |
| R6 | −1.0111E+00 | 2.1353E−03 | −5.7134E−04 | 5.6535E−05 | −1.4500E−06 | −1.4054E−07 |
| | Conic constant | Aspheric coefficient | | | | |
| | k | A14 | A16 | A18 | A20 | A22 |
| R1 | −5.1243E−01 | −4.3945E−10 | 1.6044E−11 | −4.4453E−13 | 9.3257E−15 | −1.4526E−16 |
| R2 | −9.9000E+01 | 2.3168E−10 | −5.5725E−12 | 7.9229E−14 | −6.8759E−16 | 3.5254E−18 |
| R3 | −1.0503E+01 | 5.7283E−08 | −2.9408E−09 | 1.0896E−10 | −2.9111E−12 | 5.5687E−14 |
| R4 | −3.1828E+01 | 5.5077E−08 | −3.3949E−09 | 1.4588E−10 | −4.4259E−12 | 9.5137E−14 |
| R5 | −2.6216E+00 | 1.9201E−09 | −1.3567E−10 | 3.1090E−12 | −4.1906E−15 | −1.3954E−15 |
| R6 | −1.0111E+00 | 1.4364E−08 | −5.9336E−10 | 1.1474E−11 | 1.6338E−14 | −6.2742E−15 |

| | Conic constant | Aspheric coefficient | | | | |
|---|---|---|---|---|---|---|
| | k | A24 | A26 | A28 | A30 | / |
| R1 | −5.1243E−01 | 1.6168E−18 | −1.2068E−20 | 5.3815E−23 | −1.0790E−25 | / |
| R2 | −9.9000E+01 | −9.6743E−21 | 1.3505E−23 | −2.5895E−26 | 2.2376E−29 | / |
| R3 | −1.0503E+01 | −7.4573E−16 | 6.6510E−18 | −3.5522E−20 | 8.5961E−23 | / |
| R4 | −3.1828E+01 | −1.4272E−15 | 1.4296E−17 | −8.6362E−20 | 2.3917E−22 | / |
| R5 | −2.6216E+00 | 3.3221E−17 | −3.5855E−19 | 1.9444E−21 | −4.6816E−24 | / |
| R6 | −1.0111E+00 | 1.4890E−16 | −1.6907E−18 | 9.8818E−21 | −2.6083E−23 | / |

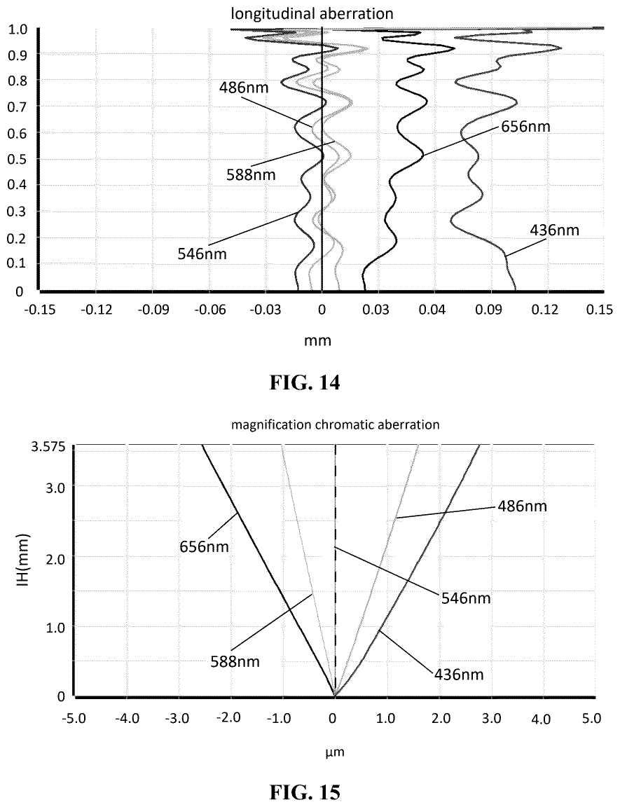

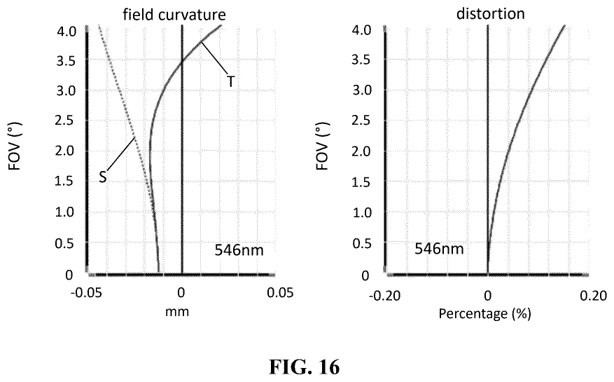

FIG. 14 and FIG. 15 show the longitudinal aberration and magnification chromatic aberration after light with a wavelength respectively of 656 nm, 588 nm, 546 nm, 486 nm and 436 nm passes the camera optical lens 40 in the fourth embodiment. FIG. 16 shows the field curvature and distortion after light with a wavelength of 546 nm passes the camera optical lens 40 in the fourth embodiment, where the field curvature S in FIG. 16 denotes a field curvature in the sagittal direction, and T denotes a field curvature in the meridian direction.

In this embodiment, the entrance pupil diameter ENPD of the camera optical lens 40 is 16.735 mm, the image height IH at 1.0 field is 3.575 mm, a field of view FOV at 1.0 field is 8.13°, IHm is 3.695 mm, and FOVm is 8.40°. The camera optical lens 40 satisfies design requirements for large aperture, telephoto capability, and miniaturization. It achieves full correction of both on-axis and off-axis chromatic aberrations while exhibiting excellent optical characteristics.

### Fifth Embodiment

The meanings of the symbols of the fifth embodiment are the same as those of the first embodiment.

It differs from the first embodiment in that: The object side surface of the second lens L2 is concave in the paraxial region.

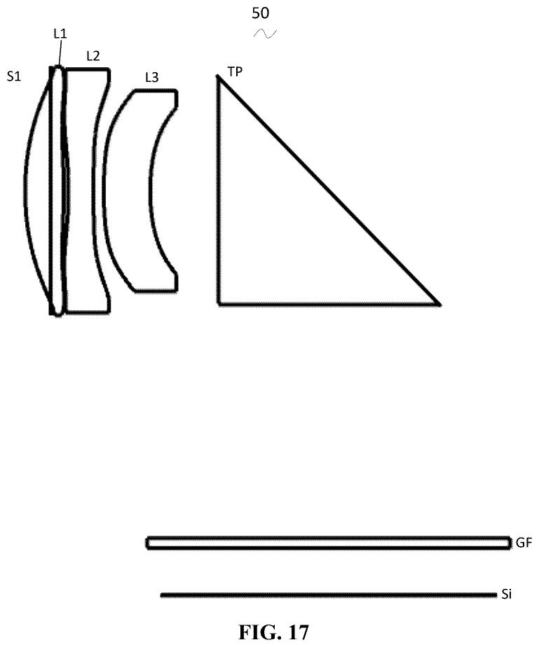

FIG. 17 shows a camera optical lens 50 according to a fifth embodiment of the present disclosure.

Tables 9 and 10 show design data of the camera optical lens 50 according to the fifth embodiment of the present disclosure.

TABLE 9

| | R | d | | nd | | vd | |
|---|---|---|---|---|---|---|---|
| S1 | ∞ | d0= | −0.556 | | | | |
| R1 | 5.499 | d1= | 0.846 | nd1 | 1.8489 | vd1 | 40.04 |
| R2 | −20.964 | d2= | 0.105 | | | | |
| R3 | −13.471 | d3= | 0.550 | nd2 | 1.6488 | vd2 | 21.02 |
| R4 | 10.984 | d4= | 0.229 | | | | |
| R5 | 7.117 | d5= | 1.024 | nd3 | 1.5444 | vd3 | 55.82 |
| R6 | 4.265 | d6= | 1.500 | | | | |
| R7 | ∞ | d7= | 4.860 | nd4 | 1.5891 | vd4 | 61.25 |
| R8 | ∞ | d8= | 5.000 | | | | |
| R9 | ∞ | d9= | 0.210 | ndg | 1.5168 | vdg | 64.17 |
| R10 | ∞ | d10= | 1.008 | | | | |

Table 10 shows the aspherical data of the lenses in the camera optical lens 50 of the fifth embodiment of the present disclosure.

TABLE 10

| | |
|---|---|
| Conic constant | Aspheric coefficient |

| | k | A4 | A6 | A8 | A10 | A12 |
|---|---|---|---|---|---|---|
| R1 | −2.0948E+00 | 2.3379E−03 | 3.1393E−04 | 1.7417E−04 | −1.4606E−04 | 3.5699E−05 |
| R2 | 5.2870E+01 | −1.8289E−02 | 2.9068E−02 | −1.7518E−02 | 7.8931E−03 | −2.7561E−03 |
| R3 | −7.2421E+00 | −6.2402E−02 | 7.8726E−02 | −5.1563E−02 | 2.4461E−02 | −8.5806E−03 |
| R4 | 1.8024E+01 | −6.8979E−02 | 8.3711E−02 | −5.7166E−02 | 2.9830E−02 | −1.1847E−02 |
| R5 | 4.3794E−01 | −2.7792E−02 | 5.3289E−02 | −3.4775E−02 | 1.7365E−02 | −6.7358E−03 |
| R6 | 3.1321E−01 | 1.2682E−02 | 3.4813E−03 | 1.5840E−03 | −7.8993E−03 | 1.0455E−02 |

| | Conic constant | Aspheric coefficient | | | | |
|---|---|---|---|---|---|---|
| | k | A14 | A16 | A18 | A20 | A22 |
| R1 | −2.0948E+00 | −4.7418E−06 | 7.2983E−07 | −1.7497E−07 | 2.6926E−08 | −1.9443E−09 |
| R2 | 5.2870E+01 | 6.9592E−04 | −1.2077E−04 | 1.3902E−05 | −1.0151E−06 | 4.2918E−08 |
| R3 | −7.2421E+00 | 2.1655E−03 | −3.8320E−04 | 4.6250E−05 | −3.6359E−06 | 1.6868E−07 |
| R4 | 1.8024E+01 | 3.4095E−03 | −6.8875E−04 | 9.4705E−05 | −8.4360E−06 | 4.3965E−07 |
| R5 | 4.3794E−01 | 1.9110E−03 | −3.8065E−04 | 5.1427E−05 | −4.4742E−06 | 2.2330E−07 |
| R6 | 3.1321E−01 | −7.5439E−03 | 3.3383E−03 | −9.2880E−04 | 1.5805E−04 | −1.5004E−05 |

| | Conic constant | Aspheric coefficient | | | | |
|---|---|---|---|---|---|---|
| | k | A24 | A26 | A28 | A30 | / |
| R1 | −2.0948E+00 | 4.7064E−11 | 0.0000E+00 | 0.0000E+00 | 0.0000E+00 | / |
| R2 | 5.2870E+01 | −8.1311E−10 | 0.0000E+00 | 0.0000E+00 | 0.0000E+00 | / |
| R3 | −7.2421E+00 | −3.5208E−09 | 0.0000E+00 | 0.0000E+00 | 0.0000E+00 | / |
| R4 | 1.8024E+01 | −1.0219E−08 | 0.0000E+00 | 0.0000E+00 | 0.0000E+00 | / |
| R5 | 4.3794E−01 | −4.6407E−09 | 0.0000E+00 | 0.0000E+00 | 0.0000E+00 | / |
| R6 | 3.1321E−01 | 6.0808E−07 | 0.0000E+00 | 0.0000E+00 | 0.0000E+00 | / |

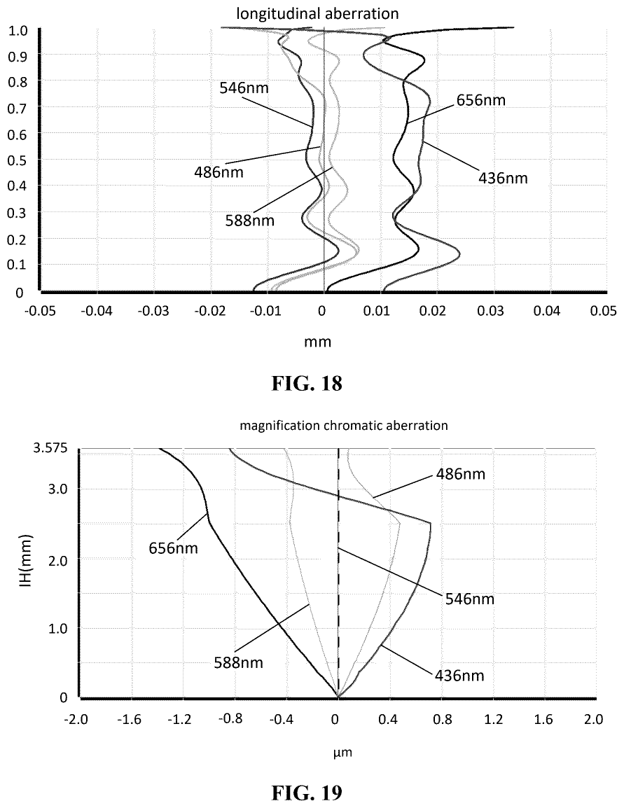

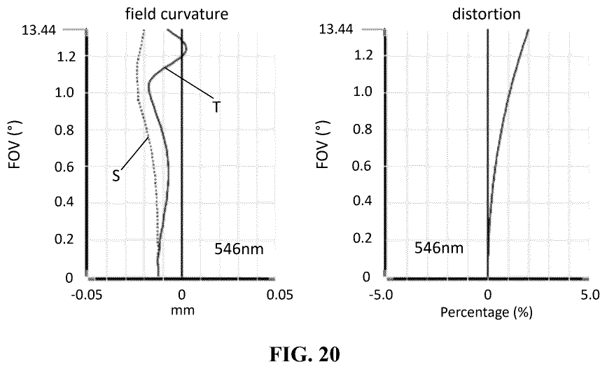

FIG. 18 and FIG. 19 show the longitudinal aberration and magnification chromatic aberration after light with a wavelength respectively of 656 nm, 588 nm, 546 nm, 486 nm and 436 nm passes the camera optical lens 50 in the fifth embodiment. FIG. 20 shows the field curvature and distortion after light with a wavelength of 546 nm passes the camera optical lens 50 in the fifth embodiment, where the field curvature S in FIG. 20 denotes a field curvature in the sagittal direction, and T denotes a field curvature in the meridian direction.

In this embodiment, the entrance pupil diameter ENPD of the camera optical lens 50 is 5.101 mm, the image height UT at 1.0 field is 3.575 mm, a field of view FOV at 1.0 field is 26.890, IHm is 3.695 mm, and FOVm is 27.720. The camera optical lens 50 satisfies design requirements for large aperture, telephoto capability, and miniaturization. It achieves full correction of both on-axis and off-axis chromatic aberrations while exhibiting excellent optical characteristics.

The following Table 11 shows the values of the various parameters and the specified operation expressions of the first, second, third, fourth, and fifth embodiments.

TABLE 11

| Parameters | 1^{st} | 2^{nd} | 3^{rd} | 4^{th} | 5^{th} |
|---|---|---|---|---|---|
| and | embodi- | embodi- | embodi- | embodi- | embodi- |
| conditions | ment | ment | ment | ment | ment |
| D/TTL | 0.16 | 0.12 | 0.20 | 0.12 | 0.18 |
| D/f | 0.16 | 0.13 | 0.22 | 0.12 | 0.19 |
| ndi | 1.50 | 1.50 | 1.50 | 1.50 | 1.85 |
| \|SAG32\|/SD32 | 0.52 | 0.45 | 0.45 | 0.45 | 0.32 |
| f3*d5/(R5 − R6) | −11.82 | −7.99 | −20.03 | −8.00 | −8.00 |
| f | 18.269 | 16.282 | 15.151 | 50.204 | 14.644 |
| f1 | 8.924 | 8.867 | 9.072 | 26.046 | 5.178 |
| f2 | −53.638 | −53.988 | −80.958 | −107.178 | −9.141 |
| f3 | −15.812 | −20.621 | −21.945 | −68.395 | −22.292 |
| f12 | 10.430 | 10.260 | 10.606 | 31.933 | 10.250 |
| Fno | 2.871 | 2.871 | 2.878 | 3.000 | 2.871 |
| TTL | 18.986 | 17.746 | 16.666 | 49.697 | 15.332 |
| IH | 3.575 | 3.575 | 3.575 | 3.575 | 3.575 |
| FOV | 21.79° | 24.47° | 26.02° | 8.13° | 26.89° |
| SAG32 | 1.113 | 0.955 | 0.807 | 2.819 | 0.579 |
| SD32 | 2.157 | 2.119 | 1.795 | 6.253 | 1.787 |

Those of ordinary skill in the art can understand that the aforementioned embodiments are specific examples for implementing the present disclosure. In practical applications, various modifications can be made to them in form and detail without deviating from the spirit and scope of the present disclosure.

What is claimed is:

1. A camera optical lens comprising, arranged in sequence from an object side to an image side: a first lens with a positive refractive power, a second lens with a negative refractive power, a third lens with a negative refractive power, and a triangular prism, with at least one of the first lens, second lens, and third lens being a glass lens; wherein
an on-axis distance from the object side surface of the first lens to the image side surface of the third lens is denoted as D, a total track length of the camera optical lens is denoted as TTL, a focal length of the camera optical lens is denoted as f, a refractive index of the glass lens in the camera optical lens is denoted as ndi, a sagittal height at a maximum optical effective diameter of the image side surface of the third lens is denoted as SAG32, half of the maximum optical effective diameter of the image side surface of the third lens is denoted as SD32, a focal length of the third lens is denoted as f3, an on-axis thickness of the third lens is denoted as d5, a curvature radius of the object side surface of the third lens is denoted as R5, a curvature radius of the image side surface of the third lens is denoted as R6, and the camera optical lens satisfies:
$$0.11 \leq D / TTL \leq 0.2 ;$$
$$0.1 \leq D / f \leq 0.22 ;$$
$$1.49 \leq ndi \leq 1.85 ;$$
$$( 0.32 \leq \vert SAG 32 \vert / SD 32 \leq 0.52 ;$$
$$- 20.03 \leq f 3 * d 5 / ( R 5 - R 6 ) \leq - 7.99 .$$

2. The camera optical lens according to claim 1, wherein a combined focal length of the first lens and the second lens is denoted as f12, and the camera optical lens satisfies:
$$0.57 \leq f 12 / f \leq 0.71 .$$

3. The camera optical lens according to claim 1, wherein an on-axis thickness of the first lens is denoted as d1, and an edge thickness of the first lens is denoted as ET1, satisfying:
$$2.48 \leq d 1 / ET 1 \leq 4.04 .$$

4. The camera optical lens according to claim 1, wherein the object side surface of the first lens is convex in a paraxial region; f1 denotes a focal length of the first lens, R1 denotes a curvature radius of the object side surface of the first lens, R2 denotes a curvature radius of the image side surface of the first lens, and d1 denotes an on-axis thickness of the first lens, satisfying:
$$0.35 \leq f 1 / f \leq 0.6 ;$$
$$- 1.65 \leq ( R 1 + R 2 ) / ( R 1 - R 2 ) \leq - 0.58 ;$$
$$0.055 \leq d 1 / TTL \leq 0.092 .$$

5. The camera optical lens according to claim 1, wherein f2 denotes a focal length of the second lens, R3 denotes a curvature radius of the object side surface of the second lens, R4 denotes a curvature radius of the image side surface of the second lens, and d3 denotes an on-axis thickness of the second lens, satisfying:
$$- 5.35 \leq f 2 / f \leq - 0.62 ;$$
$$- 16.01 \leq ( R 3 + R 4 ) / ( R 3 - R 4 ) \leq 11.06 ;$$
$$0.012 \leq d 3 / TTL \leq 0.036 .$$

6. The camera optical lens according to claim 1, wherein the object side surface of the third lens is convex in a paraxial region, and the image side surface of the third lens is concave in the paraxial region, and the camera optical lens satisfies:
$$- 1.53 \leq f 3 / f \leq - 0.86 ;$$
$$3.99 \leq ( R 5 + R 6 ) / ( R 5 - R 6 ) \leq 7.77 ;$$
$$0.006 \leq d 5 / TTL \leq 0.067 .$$

7. The camera optical lens according to claim 1, wherein an F-number of the camera optical lens is denoted as Fno, satisfying:
$$Fno \leq 3. .$$

8. The camera optical lens according to claim 1, wherein the total track length TTL of the camera optical lens and an image height UH of the camera optical lens at 1.0 field satisfy:
$$TTL / IH \leq 13.91 .$$

9. The camera optical lens according to claim 1, wherein the triangular prism is made of glass material.
